(19) United States
(12) Patent Application Publication
(10) Pub. No.: US 2005/0059909 A1
(43) Pub. Date: Mar. 17, 2005

(54) Cervical heat and vibration massage apparatus

(76) Inventor: Dorothy M. Burgess, Sunrise, FL (US)

Correspondence Address: Mark D. Bowen;Stearns Weaver Miller, et al., Suite 1900, 200 East Broward Boulevard, Fort Lauderdale, FL, 33301, US

(21) Appl. No.: 10/659,994

(22) Filed: Sep. 11, 2003

(51) Int. Cl. A61H 23/02; A61H 1/00

(52) U.S. Cl. 601/15; 601/70; 601/71; 601/79

(57) ABSTRACT

A compact, neck massager configured as a collar-type device adapted to be worn about a persons neck and adapted for providing the most effective natural relaxation therapies, namely gentle vibration and soothing heat to the neck and spine is disclosed. The device generally comprises a collar sculpted to fit comfortably around the neck and secured by flexible straps with connectable ends to facilitate removable attachment of the device around the user's neck. The collar includes a housing containing an electric motor powered alternatively by a battery or AC power source. The electric motor is adapted with an output shaft having an eccentric mass for converting rotational movement of a motor into a vibration movement for transmission to the cervical area through the housing. The device further includes a heating band disposed on the inner surface thereof for selectively transmitting heat to the cervical area. A control circuit is provided to enable the user to selectively vary the power supplied between the electric motor and heating element thereby varying the transmission of therapeutic vibration and heat to the neck. The electrical components are configured to function as an RLC circuit such that system oscillates between heat and vibration thereby maximizing therapeutic benefits.

### CROSS REFERENCE TO RELATED APPLICATIONS

N/A

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights rights whatsoever.

### BACKGROUND OF THE INVENTION

1. Field of the Invention

The present invention relates to therapeutic devices for the relief of pain. More particularly the present invention relates to a cervical massage device for applying variable vibration massage action and heat to the human body, particularly the cervical area in the form of a device specifically adapted to be worn around the user's neck.

2. Description of Related Art

The prior art has recognized many of the benefits gained by the application of vibratory displacements to various areas of the human body. Massaging devices, in general, are old and well known, and the common benefits of massage on muscular tissue are old and well documented. Massaging devices specifically adapted for the neck area, however, are less common. As will be seen, the present invention provides a new and beneficial form of vibratory input to the cervical area that has been found to be particularly useful in providing relaxation and relief from pain. The instant invention can relieve tension, stress, and pain from the cervical region of the body.

Neck pain is a common problem in today's world, with whiplash injuries, sports injuries, fatigue, and other causes producing innumerable cases of such pain. In many cases, massaging the back of the head and neck, can provide considerable relief from such pain by relieving the stress in the neck and upper back muscles. In addition, the application of heat to the cervical area has been found to provide significant therapeutic benefits. Accordingly, various massage devices designed for providing massage movements for the neck have been developed over the years.

Various massage devices known in the art incorporate vibrating mechanisms to generate therapeutic massage. The vibration-type massage device is typically designed to convert a rotation movement of a motor into a vibration movement of a massage head. A number of prior art vibration-type massage devices utilize a vibration source limited to the application of a single frequency of vibration in a single direction at a fixed amplitude thus severely limiting the potential benefits of the vibrations. For example the vibration of the neck muscles depends upon the mass of the muscles and the resilience of connective tissue that varies from person to person. If one of these single frequency prior art devices were adequate for one particular person it would likely not be adequate for another person.

Accordingly, there exists a need for a cervical massage device capable of operating at separately adjustable frequencies so as to provide mild to vigorous massaging stimulant transmitted throughout the cervical region. The device is further adapted for applying heat to the cervical area further providing therapeutic benefits. The flexibility and adjustability of the instant invention allows for anyone to find the settings that will afford them the most benefit.

### BRIEF SUMMARY OF THE INVENTION

The present invention overcomes the disadvantages and limitations in the art by providing a compact, use-anywhere neck massager configured as a collar-type device adapted to be worn about a persons neck and adapted for providing the most effective natural relaxation therapies, namely gentle vibration and soothing heat to the neck and spine. The device provides relief from muscle pain and strain brought on by everyday activities like driving, flying, working at a computer, or carrying a backpack. The device generally comprises a collar of rubber or foam sculpted to fit comfortably around the neck and secured by flexible straps with ends adapted with hook and loop fastening material to facilitate removable attachment of the device around the user's neck. The collar includes a housing containing an electric motor powered alternatively by a battery or AC power source. The electric motor is adapted with an output shaft having an eccentric mass for converting rotational movement of a motor into a vibration movement for transmission to the cervical area through the housing. In addition, the device includes a heating band disposed on the inner surface thereof for selectively transmitting heat to the cervical area. A control circuit is provided to enable the user to selectively vary the power supplied between the electric motor and heating element thereby varying the transmission of therapeutic vibration and heat to the neck. The electrical components are configured to function as an RLC circuit such that system oscillates between heat and vibration thereby maximizing therapeutic benefits.

Accordingly, it is an object of the present invention to provide an improved cervical massaging device.

Another object of the present invention is to provide a cervical massaging device configured as a collar of rubber or foam sculpted to fit comfortably around the neck.

Still another object of the present invention is to provide a cervical massaging device that transmits vibration and heat to the user's neck and upper back.

Yet another object of the present invention is to provide a cervical massaging device capable of transmitting vibration and heat in an oscillating manner.

### BRIEF DESCRIPTION OF THE SEVERAL VIEWS OF THE DRAWINGS

FIG. 1 is a top rear perspective view of a cervical massaging device according to the present invention;

FIG. 2 is top right front perspective view thereof;

FIG. 3 is a top view thereof;

FIG. 4 is an exploded view thereof;

FIG. 5 is a front top perspective view thereof;

FIG. 6 is a left bottom perspective view thereof with the collar ends in an attached configuration;

FIG. 7 is a right bottom perspective view thereof;

FIG. 8 depicts the device worn by a user;

FIG. 9 is schematic view depicting the electrical and mechanical operating components;

FIG. 10 is an exploded view depicting the structural, mechanical, and electrical components;

FIG. 11 depicts an alternate embodiment cervical massaging device;

FIG. 12 is an exploded rear view thereof;

FIG. 13 is an exploded view of the component housing; and

FIG. 14 is an exploded front view thereof.

### DETAILED DESCRIPTION OF THE INVENTION

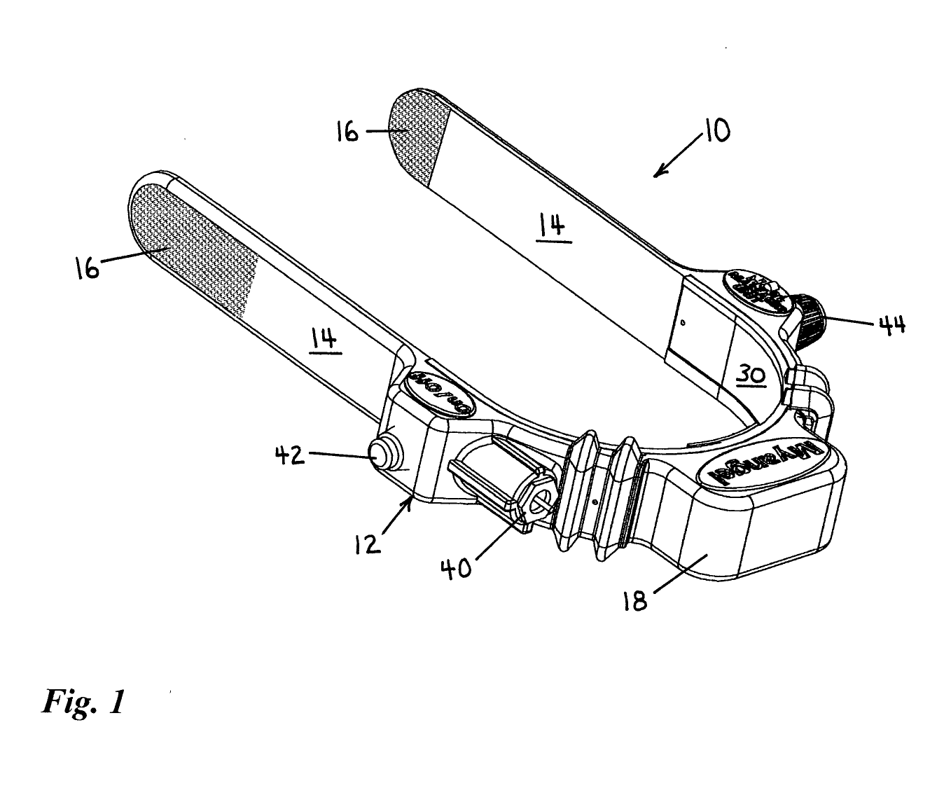

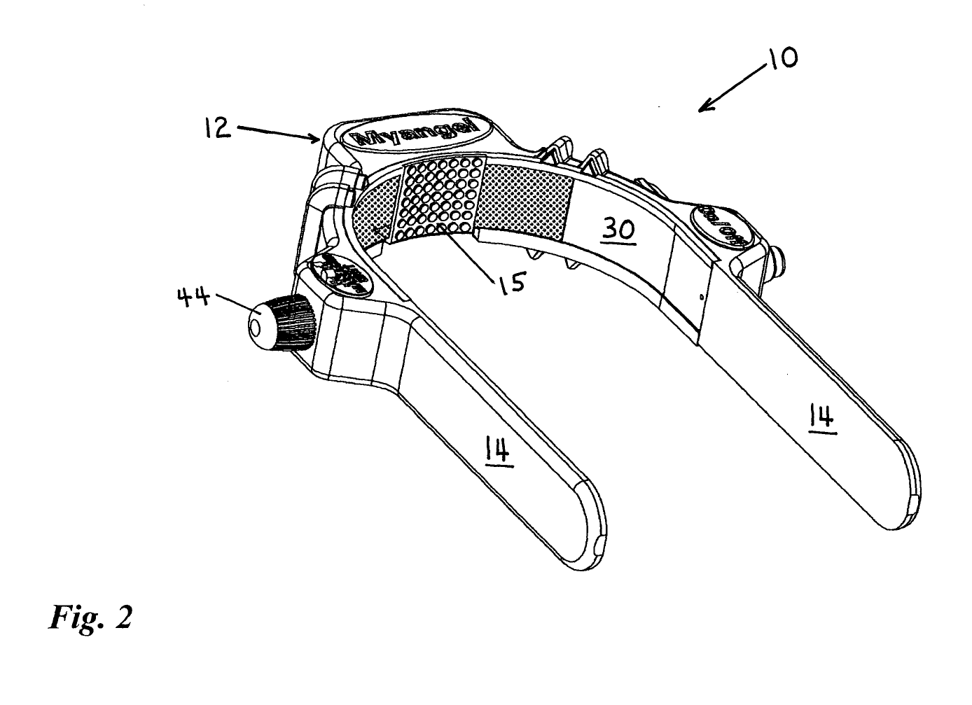

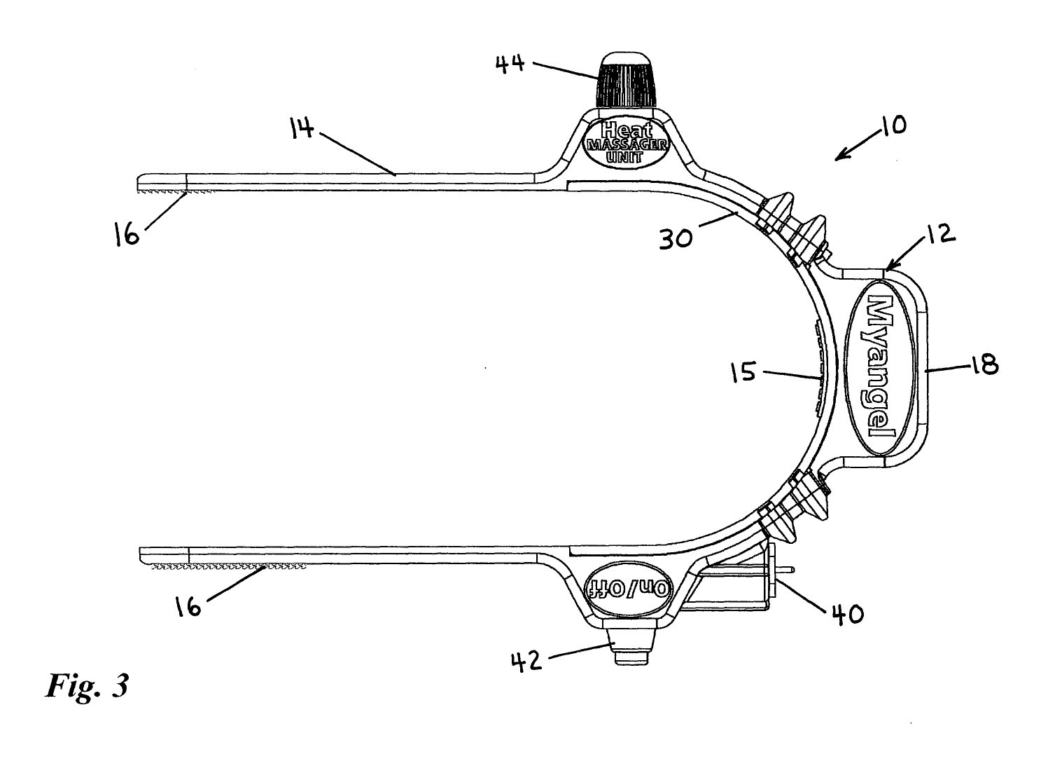

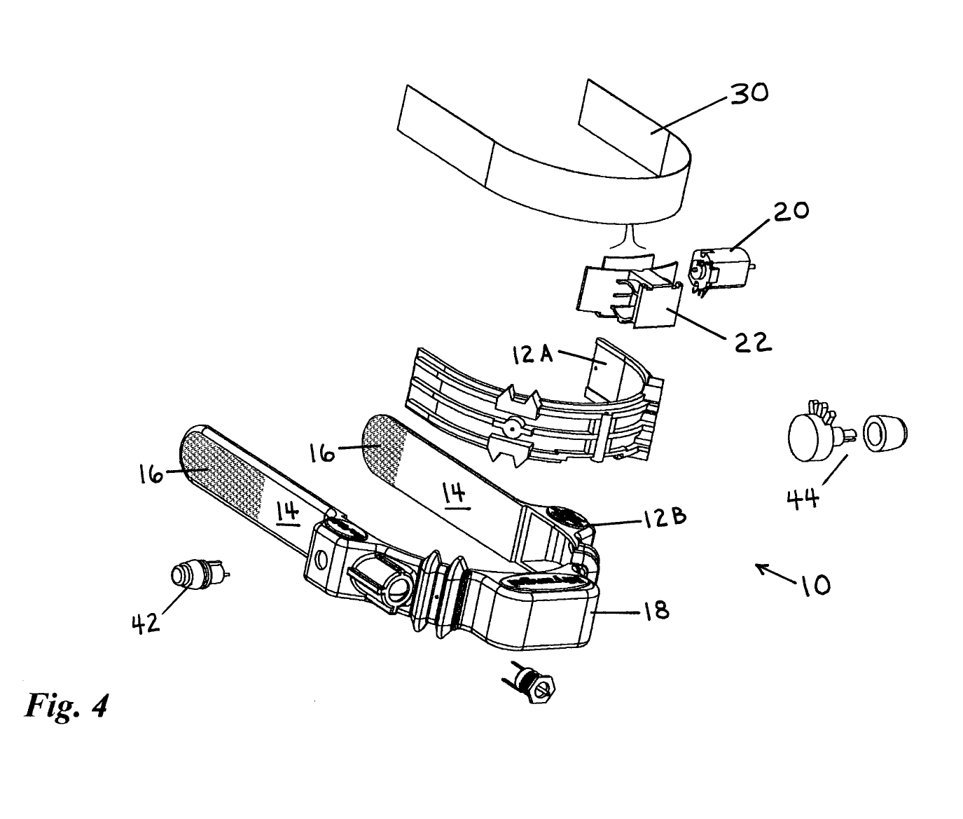

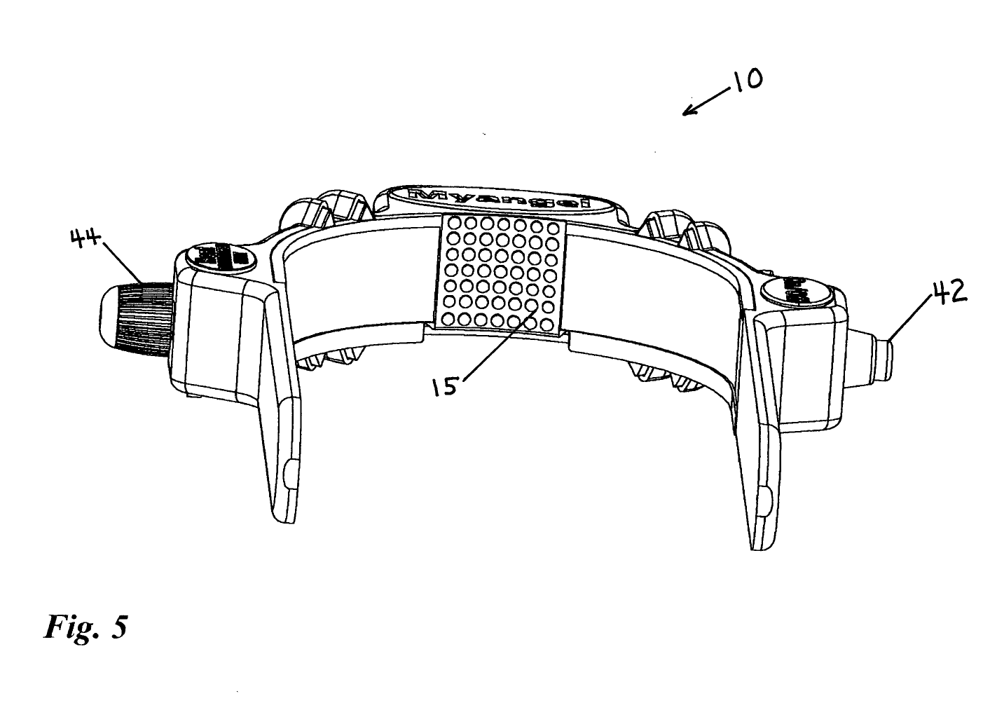

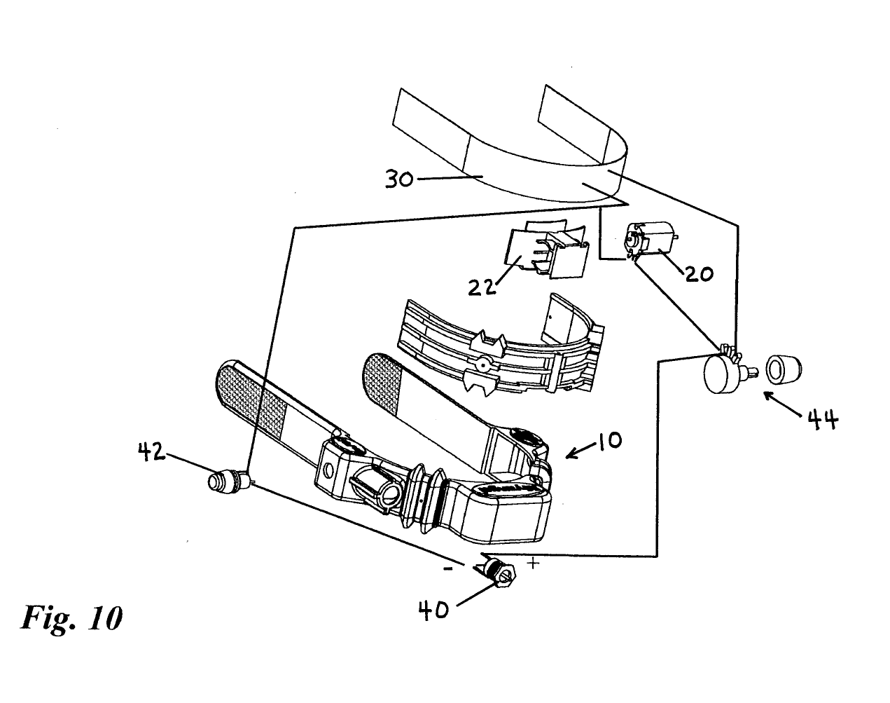

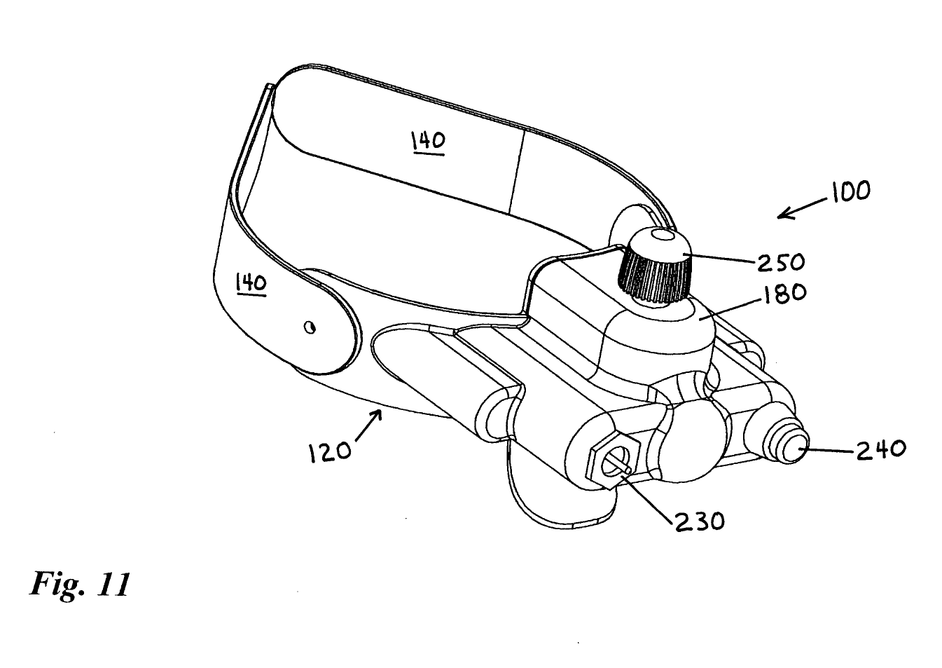

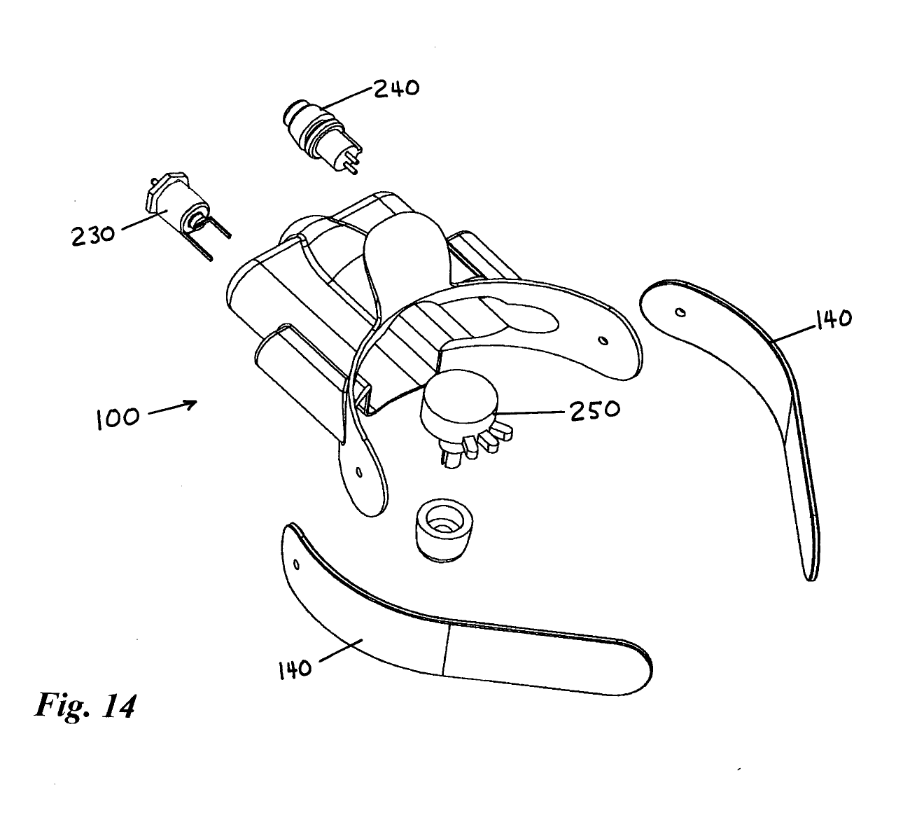

With reference now to the drawings, FIGS. 1-10 depict a preferred embodiment of a cervical massage device according to the present invention, generally referenced as 10. Cervical massage device 10 is a compact, use-anywhere neck massager configured as a collar-type device adapted to be worn about a persons neck and adapted for providing gentle vibration massage and soothing heat to the neck and spine. FIGS. 11-14 depict an alternate, battery-powered embodiment.

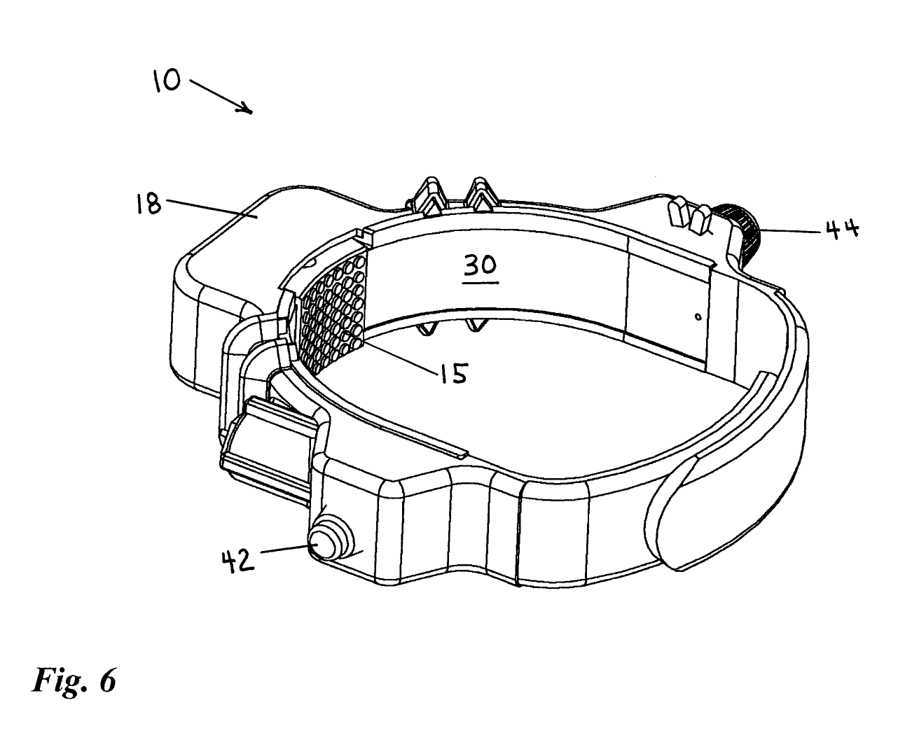

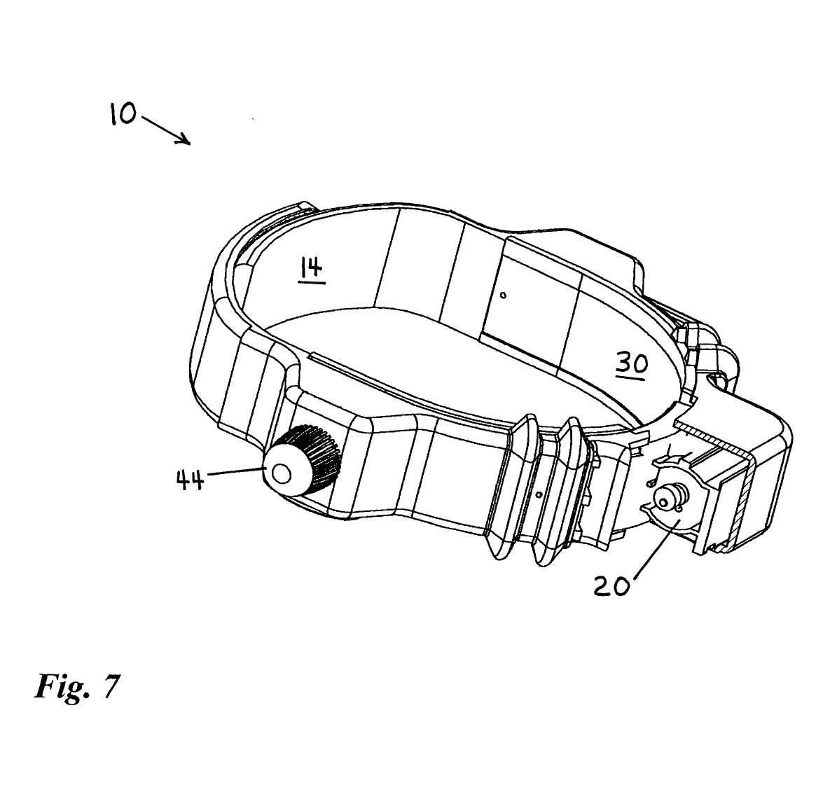

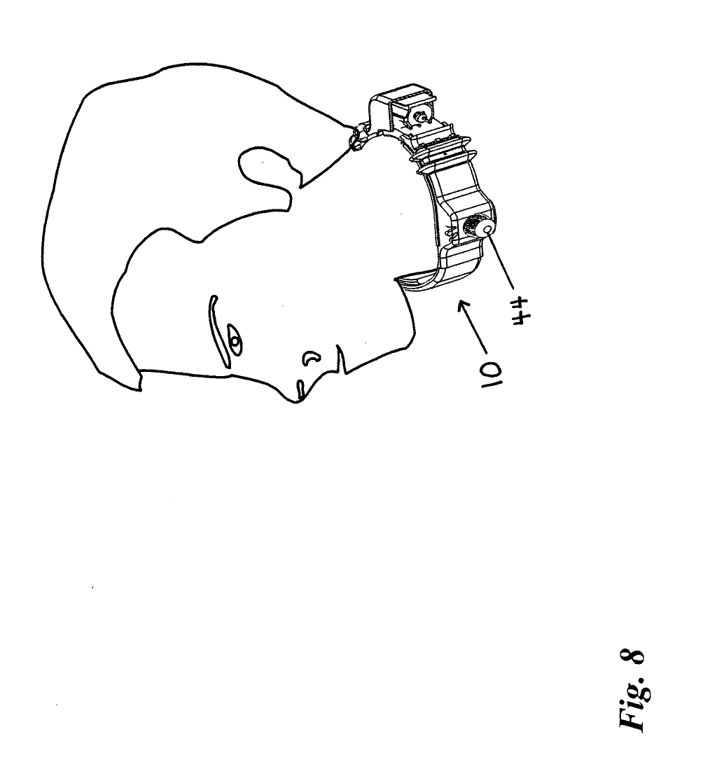

The device includes a collar, generally referenced as 12, fabricated from a rubber, foam, plastic, or any other suitable material. Collar 12 is shaped and contoured to fit comfortably around a person's neck. In the preferred embodiment, collar 12 includes a radially inner component, referenced as 12A, and a radially outer component, referenced as 12B. Components 12A and 12B are adapted for mating engagement so as to form a unitary collar component, referenced as 12. In addition, collar 12 includes flexible straps 14 with ends adapted with hook and loop fastening material 16 to facilitate removable attachment of the device around the user's neck. FIGS. 6 and 7 depict cervical collar 12, and more particularly flexible straps 14 disposed in a connected configuration secured by hook and loop fastening material 16. FIG. 8 depicts the cervical massage device 10 configured for use in an attached configuration around the neck of a user. Connected to radially inner component 12A are a series of projecting rubber nubs, referenced as 15, which function to engage the user's skin in the cervical area for transmitting vibrational forces.

Associated with collar 12 is a housing 18 containing an electric motor 20 powered alternatively by a battery or AC power source. Electric motor 20 is adapted with an output shaft having an eccentric mass (not shown) for converting rotational movement of a motor into a vibration movement as is known in the art of generating vibrational forces, for transmission to the cervical area through collar 12. Electric motor 20 is preferably received within a motor mounting structure 22 configured to adequately secure the motor during operation. Mounting structure 22 is adapted to be received and secured within housing 18 in a suitable anchored configuration.

In addition, cervical massage device 10 includes a heating band 30 disposed on the inner surface thereof for selectively transmitting heat to the cervical area. Heating band 30 is preferably a generally flat and flexible heating element connected along the radially inner wall of collar 12, such that heating band 30 is disposed in position for thermally engaging the user's skin in the cervical region. Heating band 30 is electrically connected to the battery and/or AC power source used to provide power to electric motor 20.

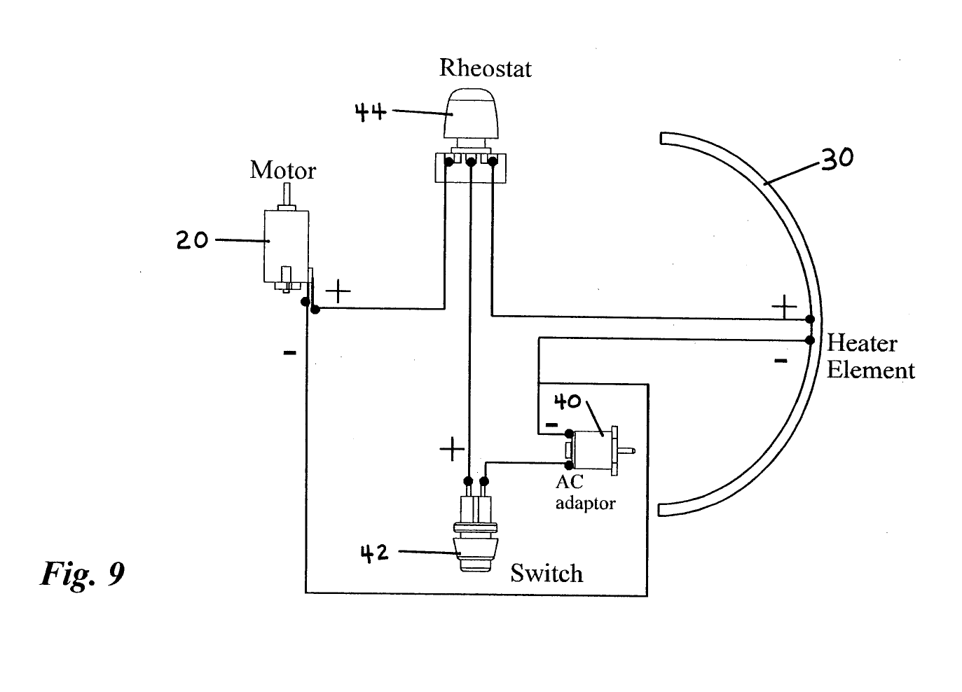

FIG. 9 depicts an electrical schematic of a preferred system for providing power and control for the electrical components of an AC powered device as depicted in FIGS. 1-10. The electrical components include an AC power input adapter 40, a manual on/off switch 42, a rheostat 44, electric motor 20, and heating element 30. AC power input adapter 40 provides a connection port for supply conventional 120 VAC current to device 10. Manual on/off switch 42 provides the user with a switch for selectively activating and deactivating device 10. A significant aspect of the present invention relates to the use of a rheostat 44 for modulating power between motor 20 and heating element 30. More particularly, the incorporation of rheostat 44 into the electrical circuit results in a resonating RLC circuit that effectively oscillates between motor 20 and heating element 30. As a result of the oscillation of power, the user enjoys alternating activation and/or amplitude of motor 20 and heating element 30, thereby providing oscillating vibration and therapeutic heating to the cervical area. Accordingly, the control circuit enables the user to selectively vary the power supplied between the electric motor 20 and heating element 30 thereby varying the transmission of therapeutic vibration and heat to the neck.

As noted above, FIGS. 11-14 depict an alternate, battery-powered embodiment, generally referenced as 100. Device 100 includes a collar, generally referenced as 120, similarly fabricated from a rubber, foam, plastic, or any other suitable material. Collar 120 is likewise shaped and contoured to fit comfortably around a person's neck, and includes a radially inner component, referenced as 120A, and a radially outer component, referenced as 120B. Components 120A and 120B are adapted for mating engagement so as to form a unitary collar component, referenced as 120. In addition, collar 120 includes flexible straps 140 that function to facilitate removable attachment of the device around the user's neck. Straps 140 are preferably semi-flexible having spring-like qualities such that the straps are biased to a “closed” configuration as seen in FIG. 11.

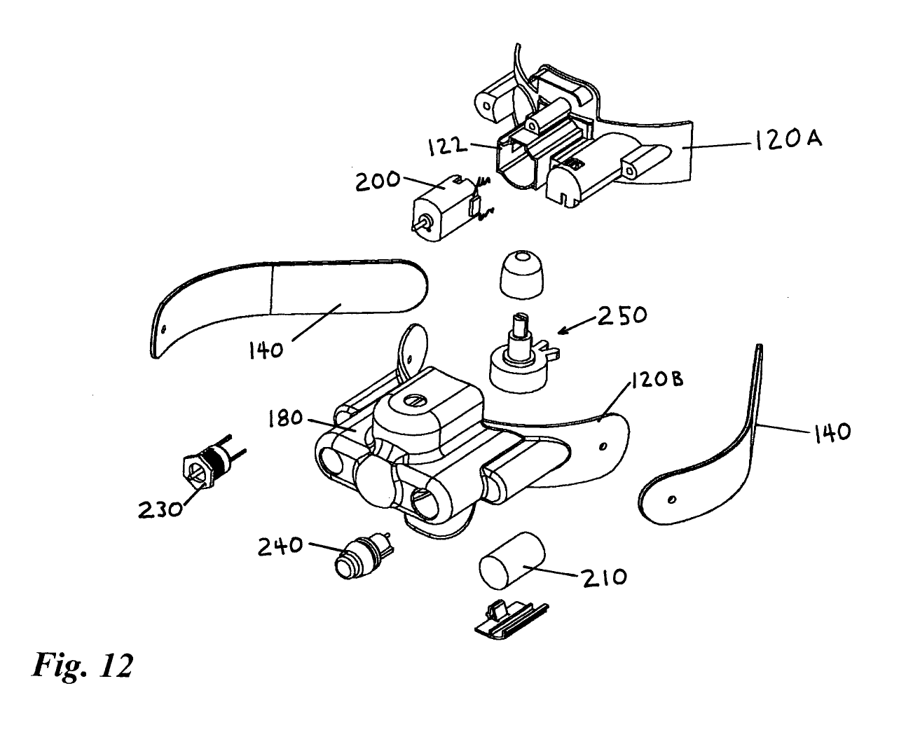

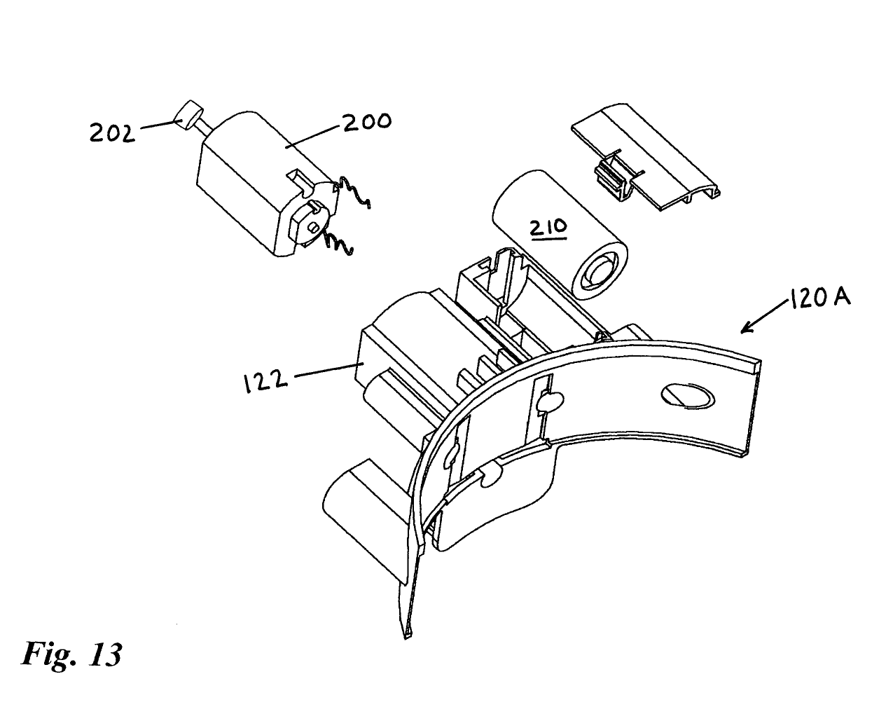

Associated with collar 120 is a housing 180 containing an electric motor 200 powered alternatively by a battery 210 or AC power source via AC power input port 230. As with the first disclosed embodiment, electric motor 200 is adapted with an output shaft having an eccentric mass 202 for converting rotational movement of a motor into a vibration movement as is known in the art of generating vibrational forces, for transmission to the cervical area through collar 120. Electric motor 200 is preferably received within a motor mounting structure 122 defined by radially inner housing component 120A as best depicted in FIGS. 12 and 13.

Cervical massage device 100 may also incorporate a heating element disposed on the inner surface thereof for selectively transmitting heat to the cervical area as previously disclosed, or may alternatively incorporate the heating elements in flexible straps 140 such that straps 140 are disposed in position for thermally engaging the user's skin in the cervical region. As with the previously disclosed embodiment, the heating elements are electrically connected to the battery and/or AC power source used to provide power to electric motor 200.

Cervical massage device 100 also includes power and control circuits for control and operation of the device as disclosed hereinabove. The electrical components include a battery power source 210, an AC power input adapter 230, a manual on/off switch 240, a rheostat 250, electric motor 200, and heating elements incorporated into straps 140. AC power input adapter 2340 provides a connection port for supply conventional 120 VAC current to device 10. Manual on/off switch 240 provides the user with a switch for selectively electrically activating and deactivating device 100. As with the previous embodiment, a significant aspect of the present invention relates to the use of a rheostat 250 for modulating power between motor 200 and heating elements in straps 140. More particularly, the incorporation of rheostat 250 into the electrical circuit results in a resonating RLC circuit that effectively oscillates between motor 200 and heating elements in straps 140. As a result of the oscillation of power, the user enjoys alternating activation and/or amplitude of motor 200 and heating elements in straps 140, thereby providing oscillating vibration and therapeutic heating to the cervical area. Accordingly, the control circuit enables the user to selectively vary the power supplied between the electric motor and heating elements thereby varying the transmission of therapeutic vibration and heat to the neck.

The instant invention has been shown and described herein in what is considered to be the most practical and preferred embodiment. It is recognized, however, that departures may be made therefrom within the scope of the invention and that obvious modifications will occur to a person skilled in the art.

1. A cervical therapeutic massager adapted to be worn about a persons neck and adapted for providing gentle vibration massage and soothing heat to the cervical region, said massager comprising:
a collar assembly having a pair of projecting flexible straps, each strap terminating in an end portion;
means for releasably connecting the end portions of said straps;
said collar having a radially inner surface including a heating element for transmitting therapeutic heat to the user's cervical region;
an electric motor mounted to said collar assembly, said electric motor having an output shaft adapted with an eccentric mass for generating vibration;
means for supplying electric power to said electric motor and said heating element, said means for supplying electric power including a manual on/off switch and a resonating RLC circuit for selectively oscillating the supply of power between said electric motor and said heating element.

2. A cervical therapeutic massager according to claim 1, wherein said means for supplying electric power includes an AC power input port.

3. A cervical therapeutic massager according to claim 1, wherein said means for supplying electric power includes at least one battery mounted to said collar.

4. A cervical therapeutic massager according to claim 1, wherein said collar further includes a plurality of projecting rubber nubs disposed on said radially inner surface for engaging the user's cervical area for transmitting vibrational forces thereto.

5. A cervical therapeutic massager according to claim 1, wherein said means for releasably connecting the end portions of said straps comprises hook and loop fastening material.

6. A cervical therapeutic massager adapted to be worn about a persons neck and adapted for providing gentle vibration massage and soothing heat to the cervical region, said massager comprising:
a collar assembly having a pair of projecting flexible straps, each strap terminating in an end portion;
means for selectively positioning said straps between an open configuration whereby said collar may be placed around a user's neck, and a closed configuration whereby said collar is secured to a user's neck;
said collar having a radially inner surface including a heating element for transmitting therapeutic heat to the user's cervical region;
an electric motor mounted to said collar assembly, said electric motor having an output shaft adapted with an eccentric mass for generating vibration;
an electric power source for supplying electric power to said electric motor and said heating element;
a manual on/off switch electrically connected to said electric power source for selectively controlling the supply of electric power to said electric motor and said heating element;
a rheostat electrically connected in series between said manual on/off switch and said electric motor and said heating element for allowing the user to vary the ratio of power supplied between said electric motor and said heating element, said rheostat further enabling a resonating RLC circuit for automatically oscillating the supply of power between said electric motor and said heating element.

7. A cervical therapeutic massager according to claim 6, wherein said electric power source comprises an AC power input port connectable to an AC power outlet via a power cord.

8. A cervical therapeutic massager according to claim 6, wherein said electric power source comprises at least one battery.

9. A cervical therapeutic massager according to claim 6, wherein said collar further includes a plurality of projecting rubber nubs disposed on said radially inner surface for engaging the user's cervical area for transmitting vibrational forces thereto.
